(19) United States
(12) Patent Application Publication
(10) Pub. No.: US 2025/0337681 A1
(43) Pub. Date: Oct. 30, 2025

(54) BGP-based service support over SRv6 networks with different SID types

(71) Applicant: Ciena Corporation, Hanover, MD (US)

(72) Inventors: Selvamani Ramasamy, Milpitas, CA (US); Muthurajah Sivabalan, Kanata (CA)

(73) Assignee: Ciena Corporation, Hanover, MD (US)

(21) Appl. No.: 18/651,496

(22) Filed: Apr. 30, 2024

(51) Int. Cl. H04L 45/00; H04L 45/02

(52) U.S. Cl. CPC H04L 45/34; H04L 45/04

(57) ABSTRACT

A Provider Edge (PE) router, in a Segment Routing over Internet Protocol version 6 (SRv6) network, is configured to perform steps of operating a SRv6-based Border Gateway Protocol (BGP) service at the PE router and with the PE router capable of supporting a plurality of Segment Identifier (SID) types in terms of structure; and advertising the SRv6-based BGP service with a BGP Update message containing Service Segment Identifier (SID) information along with a plurality of Service SID Structure information, including one for each of the plurality of SID types.

### FIELD OF THE DISCLOSURE

The present disclosure relates generally to networking. More particularly, the present disclosure relates to systems and methods for Border Gateway Protocol (BGP)-based service support over Segment Routing over Internet Protocol version 6 (SRv6) networks with different Segment Identifier (SID) types

### BACKGROUND OF THE DISCLOSURE

SRv6-based BGP services refer to network services that leverage both SRv6, as the data plane, and BGP, as the service signaling protocol, to provide Layer 2 (L2) and Layer 3 (L3) overlay services. For example, the L2 and L3 overlay services are described in RFC 9252, BGP Overlay Services Based on Segment Routing over IPv6 (SRv6), July 2022, the contents of which are incorporated by reference, and can include L3 Virtual Private Network (L3VPN), Ethernet VPN (EVPN), etc. SRv6 extends the segment routing paradigm with IPv6, enabling the encoding of routing instructions directly within IPV6 addresses, known as Segment IDs (SIDs). SRv6 SIDs are advertised using BGP, enabling the dissemination of SRv6 routing information across the network, allowing routers to make informed path selection decisions based on SRv6 segments. SRv6 enables the definition of specific behaviors (functions) at the endpoints (e.g., routers) that process the SRv6 packets. When combined with BGP, it's possible to create highly customized paths across the network that cater to the requirements of different services, such as VPNs, traffic engineering, Quality of Service (QOS), and more.

### BRIEF SUMMARY OF THE DISCLOSURE

The present disclosure relates to systems and methods for BGP-based service support over SRv6 networks with different SID types. There are different types of SIDs that have been standardized by the IETF, such as a so-called classical SID (also referred to as an uncompressed SID, etc.), a micro SID (uSID), etc., and these differ in how information is packed into a Segment Routing Header (SRH). A SRv6 Service SID refers to an SRv6 SID associated with service specific SRv6 endpoint behaviors on the advertising Provider Edge (PE) router. With respect to BGP overlay services based on SRv6, the BGP prefix SID attribute, as defined in RFC 8669, Segment Routing Prefix Segment Identifier Extensions for BGP, December 2019, the contents of which are incorporated by reference, is extended to carry SRv5 SIDs and their associated information with the BGP address families. However, with RFC 8669 and 9252, when an egress PE router (advertising PE router) supports more than one SID type (e.g., classical SID, uSID, or other type of SID), the egress PE router needs to allocate a separate Function SID and advertise it as a separate Service SID (Sub-Type-Length-Value (TLV)) along with the corresponding SID structure (Sub-Sub-TLV) for each supported SID. With this approach the hardware resource usage as well as control-plane processing cycle is suboptimal.

Accordingly, for BGP-based service support over SRv6 networks with different SID type, the present disclosure provides a mechanism to allow BGP speakers to advertise multiple Service SID structure information, such as in a Sub-Sub-TLV, one corresponding to each SID type that the egress PE supports along with one service SID Sub-TLV. With this mechanism, the egress PE can interoperate with different vendors supporting different SID types in an optimal way, can support new SID types as they are defined for better packing efficiency, and the like. Advantageously, the various techniques described herein:

(1) enable network operators to migrate from one SID type to another gracefully, as well as deploy network nodes from multiple vendors supporting different SID types.

(2) reduce hardware resource usage, on network devices, to support different SID types.

(3) optimize the control plane load.

(4) reduce operations overhead (less messages) with minimal configuration.

(5) support and reduce troubleshooting for network configuration problems.

In an embodiment, a method includes steps, an apparatus, network element, node, circuit, etc. is configured to implement the steps, and a non-transitory computer-readable medium stores instructions that, when executed, cause a router or other circuitry to implement the steps. The steps include operating a SRv6-based Border Gateway Protocol (BGP) service at the PE router and with the PE router capable of supporting a plurality of Segment Identifier (SID) types in terms of structure; and advertising the SRv6-based BGP service with a BGP Update message containing Service Segment Identifier (SID) information along with a plurality of Service SID Structure information, including one for each of the plurality of SID types.

The steps can further include receiving a packet for the SRv6-based BGP service from another PE router in the SRv6 network, with a corresponding SID based on one of the plurality of SID types. The steps can further include receiving a packet for the SRv6-based BGP service from another PE router in the SRv6 network, with a corresponding SID based on one of the plurality of SID types, the corresponding SID selected based on one of capability of the another PE router and local policy.

The Service SID information can be a Service SID Type-Length-Value (TLV) having a Service SID TLV type that designates there are the plurality of Service SID Structure information. The Service SID information can be a Service SID Type-Length-Value (TLV) having a Service SID TLV type that designates there are the plurality of Service SID Structure information, and the plurality of Service SID Structure information each include a SID Structure Sub-Sub-TLV.

The plurality of SID types can include an uncompressed SID and a micro SID (uSID). The steps can further include receiving a configuration for the plurality of SID types for the SRv6-based BGP service. The steps can further include exchanging a capability with one or more other PE routers in the SRv6 network; for any of the one or more other PE routers supporting the BGP Update message containing Service SID information along with the plurality of Service SID Structure information, performing the advertising. The steps can further include, for any of the one or more other PE routers not supporting the BGP Update message containing Service SID information along with the plurality of Service SID Structure information, advertising the SRv6-based BGP service with a BGP Update message containing Service SID information along with a single Service SID Structure information.

In another embodiment, a BGP speaker includes circuitry configured to receive an advertisement for a SRv6-based BGP service at an egress Provider Edge (PE) router capable of supporting a plurality of Segment Identifier (SID) types in terms of structure, wherein the advertisement is a BGP Update message containing Service Segment Identifier (SID) information along with a plurality of Service SID Structure information, including one for each of the plurality of SID types; and transmit a packet for the SRv6-based BGP service to the egress PE router in the SRv6 network, with a corresponding SID based on one of the plurality of SID types. The corresponding SID can be selected based on one of capability of another PE router and local policy.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a block diagram of SRv6 SID information with a SRv6 Service Sub-TLV and associated SRv6 Service Data Sub-Sub-TLVs for supporting multiple SID types with the same SRv6 Service Sub-TLV.

FIG. 2 is a flowchart of a process for Border Gateway Protocol (BGP)-based service support over a Segment Routing over Internet Protocol version 6 (SRv6) network with different Segment Identifier (SID) types used therein.

FIG. 3 is a flowchart of a process for a BGP speaker and BGP-based service support over a SRv6 network with different SID types used therein.

FIG. 4 is a block diagram of an example implementation of a router 100, such as a PE router, BGP speaker, etc.

FIG. 5 is a block diagram of an example processing device.

### DETAILED DESCRIPTION OF THE DISCLOSURE

Again, the present disclosure relates to systems and methods for BGP-based service support over SRv6 networks with different SID types.

### SRv6 and BGP

SRv6-based BGP services combine the capabilities of Segment Routing over IPV6 (SRv6) with Border Gateway Protocol (BGP) to create advanced Layer-2 (L2) and Layer-3 (L3) overlay services. BGP is utilized as the service signaling protocol to distribute routing and service information, while SRv6 serves as the underlying data-plane technology, enabling packet forwarding and service delivery based on IPV6 segment routing. SRv6, an extension of Segment Routing to IPV6, allows for the encoding of routing instructions directly within IPV6 addresses (called SIDs). Each SID represents a specific action or sequence of actions to be taken by the network, enabling highly flexible and efficient packet forwarding mechanisms.

In the context of L2 and L3 services, BGP is used to distribute service-related information across the network. This can include:

(1) VPN Routing and Forwarding (VRF) Information: For L3VPN services, BGP can distribute VRF information, allowing for the isolation of different customer networks over a shared infrastructure.

(2) Ethernet VPN (EVPN) Routes: For L2 services, BGP EVPN is used to distribute MAC address and VLAN information, supporting L2VPN services over the IP/MPLS network.

### Integration of SRv6 and BGP for Overlay Services

L3 Overlay Services: For L3VPN services, SRv6 enables the transport of customer IP packets over a provider's IPv6 network. Each packet is encapsulated with an SRv6 header (SRH), directing it through a specific path in the network based on the SRv6 SIDs. BGP is used to advertise the reachability of customer networks (VPNs) along with the corresponding SRv6 SIDs necessary for routing through the provider network.

L2 Overlay Services: For L2VPN services, such as point-to-point (P2P) or multipoint-to-multipoint (MP2MP) configurations, SRv6 can encapsulate Ethernet frames for transport across the IPV6 network. BGP EVPN advertises the necessary information (such as Media Access Control (MAC (addresses) and SRv6 SIDs to establish connectivity and forwarding paths between different sites.

### Key Benefits can Include

(1) Simplified Network Operations: By leveraging SRv6 for the data plane, networks can reduce the complexity associated with MPLS label management, as SRv6 uses IPv6 addresses for routing and service delivery.

(2) Enhanced Scalability and Flexibility: SRv6's ability to encode multiple instructions within a single SID and to support a wide range of services natively in IPV6 enhances network scalability and flexibility.

(3) Efficient Use of Network Resources: SRv6 allows for more efficient use of network resources by enabling explicit routing paths that can optimize bandwidth and improve load balancing.

### Srv6 Service SID

The SRv6 Service SIDs are associated with specific SRv6 Endpoint Behaviors that dictate the actions to be performed by the advertising PE router when packets arrive with the corresponding SID. Endpoint Behaviors in SRv6 describe the operations a node should perform upon receiving a packet with a specific SID in the SRH. These behaviors can range from simple packet forwarding to more complex actions like packet inspection, policy enforcement, or initiating a service function chain. The SRv6 architecture allows for the definition of various standardized behaviors as well as the possibility for vendors or network operators to define custom behaviors suited to their specific needs.

A Service SID is a type of SID that is specifically designated for invoking network services. When a packet is received with a Service SID, the advertising PE router performs the associated service-specific behavior. This might involve redirecting the packet through a firewall, a load balancer, or any other network function before sending it towards its final destination. Service SIDs enable the integration of network services directly into the SRv6 routing fabric, allowing for highly efficient and dynamic service chaining and policy enforcement.

The BGP Prefix-SID attribute (as defined in RFC 8669) is extended to carry SRv6 SIDs and their associated information with the BGP address families. The BGP Prefix-SID attribute introduced in RFC 8669 is designed to carry information about Segment Routing Prefix-SIDs associated with BGP routes. For SRv6, the concept is extended to advertise SRv6 SIDs and their associated information, enabling SRv6-based segment routing within the BGP framework. To integrate SRv6 SIDs with BGP, extensions to BGP are used to carry SRv6 SID information within BGP Update messages. These extensions allow BGP to advertise IPv6 prefixes along with the associated SRv6 SIDs. Specifically, RFC 9252 provides SRv6 Service TLVs as two new TLVs of the BGP Prefix-SID attribute to achieve signaling of SRv6 SIDs for L3 and L2 services. RFC 9252 also includes SRv6 Service Sub-TLVs for the two SRv6 Service TLVs with the SRv6 Service Sub-TLVs including SRv6 service-related information. Further, the SRv6 Service Sub-TLVs include SRv6 Service Sub-Sub-TLVs. The Sub-Sub-TLV is used to advertise properties of the SRv6 SID.

The SRv6 Service Sub-Sub-TLV of Type 1 carries the SID structure information like Locator Node Length, Function Length, Argument Length, Transposition Length and Transposition offset. Again, there are various types of SIDs standardized by the IETF. As described herein, SID type refers to the structure of the SID, i.e., uncompressed SID, uSID, generalized SID, etc., and not necessarily its function (e.g., Node SID, Prefix SID, Binding SID, Service SID, etc.). That is, the SID type is used for a receiving router to know how to reach the advertising PE, i.e., via a uSID, uncompressed SID, etc. That is, the SID type described herein refers to the way information is packed in the SRH in SRv6, and as SRv6 is a new technology, it is possible and expected that new SID types with better packing efficiency will be introduced.

### Problem Statement

The ability to support multiple SID types is an attractive capability for a node, i.e., network element, router, switch, etc. For example, such capability allows network operators to gracefully migrate their networks from one SID type to another. Another use case is multi-vendor SRv6 deployment with nodes supporting different SID types.

Again, as per RFC 9252, a Service SID (Sub-TLV) can be associated with a SID structure information (Sub-Sub-TLV). This scheme works fine if the egress PE supports only one type of SID. When the egress PE needs to support more than one SID type, then it needs to allocate separate Function SID and advertise it as a separate Service SID (Sub-TLV) along with the SID structure (Sub-Sub-TLV) for each supported SID. With this approach the hardware resource usage as well as control-plane processing cycle will be suboptimal.

### Support for Different SID Types

A BGP speaker refers to any network device (typically a router) that participates in BGP routing. This device is configured to use BGP to exchange routing information with other BGP speakers. The primary role of a BGP speaker is to learn about different network paths, advertise its own routes, and make decisions on the best paths for traffic based on policies and attributes associated with the routes. The present disclosure utilizes the term BGP speaker to refer to a device configured to advertise more than one SID type for a single Service SID, as opposed to one Service SID per SID type. BGP speakers can be routers, switches, or even software instances that use BGP to advertise, learn, and decide on the best paths for routing traffic to various destinations. A PE router is a router located at the edge of a service provider's network. It interfaces with customer networks. A PE router can be a BGP speaker when it participates in BGP routing, not all BGP speakers are PE routers. BGP speaker and peer can be used interchangeably. In general, the node with BGP support is called a BGP speaker. The peer is used when we talk about the communication between two speakers.

The present disclosure proposes a mechanism to allow BGP speakers to advertise multiple Service SID structure information Sub-Sub-TLV corresponding to each SID type that the egress PE supports along with one service SID Sub-TLV. With this mechanism, the PE can interop with different vendors supporting different SID types more efficiently, i.e., less messaging-only one BGP update, no need for separate BGP updates and separate Service SIDs for all different SID types. That is, a PE router, as a BGP speaker, can use the techniques described herein to advertise a single Service SID with multiple SID types supported, e.g., uncompressed, uSID, etc.

### Solution Detail

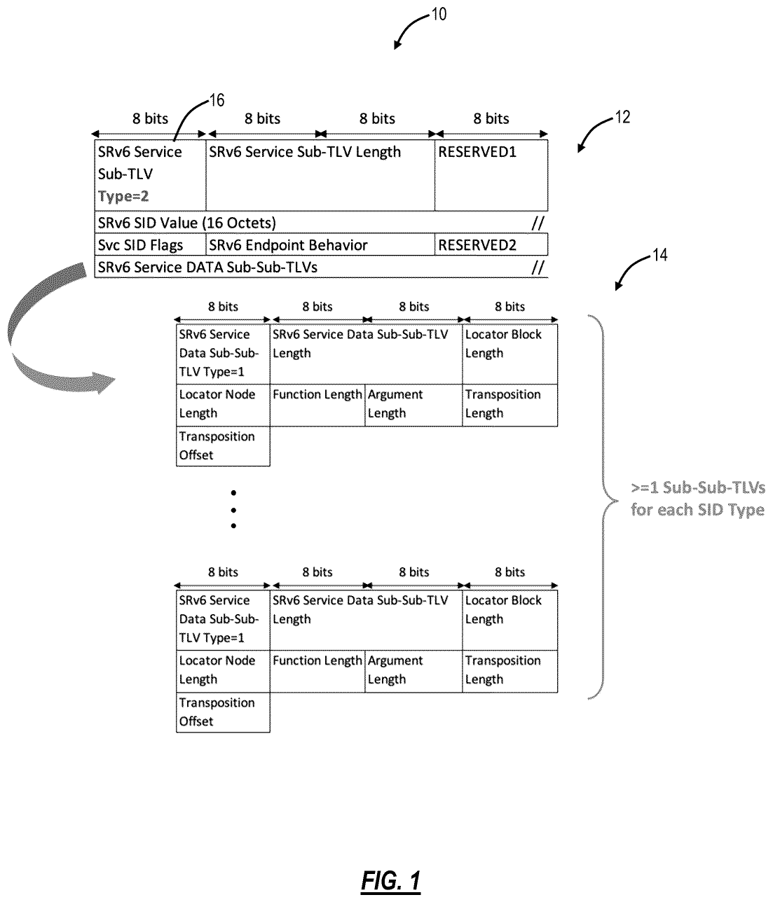

FIG. 1 is a block diagram of SRv6 SID information 10 with a SRv6 Service Sub-TLV 12 and associated SRv6 Service Data Sub-Sub-TLVs 14 for supporting multiple SID types with the same SRv6 Service Sub-TLV 12. Again, Service SID TLVs, Sub-TLVs, and Sub-Sub-TLVs are used to convey detailed information about SRv6 services and their characteristics within the network. The structure and use of TLVs, Sub-TLVs, and Sub-Sub-TLVs allow for a hierarchical and extensible way to include various pieces of information in protocol messages. The SRv6 SID information 10 contemplates use in a BGP Update message to advertise a SRv6 Service SID with multiple SID types for the same Service SID.

The SRv6 Service Sub-TLV 12 is from RFC 9252, FIG. 3, and is used to advertise the lengths of the individual parts of the SRv6 SID, as defined in [RFC8986]. The SRv6 Service Sub-TLV 12 includes a Type field 16. In RFC 9252, Section 3.1, the Type field 16 has a value of type=1, which indicates the SRv6 Service Sub-TLV 12 is being used to advertise a SRv6 Service SID with a single SID type.

The present disclosure defines a new Service SID TLV type for the Type field 18 (e.g., type=2 or any other value except 1), which will designate the SRv6 Service Sub-TLV 12 carries multiple SID Structure information via the Sub-Sub-TLV 14 for each SID type. In particular, the SRv6 Service Sub-TLV 12, with this new Service SID TLV type, will carry multiple variants of the SRv6 Service Data Sub-Sub-TLVs 14, one for each SID structure.

Upon receiving a BGP Update message with the SRv6 SID information 10, an ingress PE can select the SID type based on the types of SID supported based on the SRv6 Service Data Sub-Sub-TLVs 14, and along with local policies defined. Defining a new Service SID TLV helps in carrying further specific information (if any) and maintaining backward compatibility.

A BGP speaker capable of supporting multiple SID types for a given Service SID can advertise the routes with the new Service SID TLV type and encode multiple Service SID Structure Sub-Sub-TLVs 14. The length field of the Sub-TLV should be based on the number of Sub-Sub-TLVs as well. The TLV structure and fields of the Sub-TLV and Sub-Sub-TLVs will be as per RFC 9252. Of course, a BGP speaker supporting a single SID type for a given Service SID can advertise the routes with the Service SID TLV type=1.

### SRv6 SID Information Sub-TLV

With this solution, the new Service SID TLV type is used to assign for the SRv6 SID Information Sub-TLV 12. This Sub-TLV 12 contains a single SRv6 SID along with its properties. Its encoding is depicted below:

| Field | Length | Description |
|---|---|---|
| SRv6 | 1 | This field is set to the new Service SID TLV |
| Service | Octet | type (e.g., type = 2) to represent the SRv6 |
| Sub-TLV | | SID Information Sub-TLV with multiple SID |
| Type | | Structure Sub-Sub-TLVs. |
| SRv6 | 2 | This field contains the total length, in octets, |
| Service | Octets | of the Value field of the Sub-TLV. |
| Sub-TLV | | ***Note: The length will be based on how many |
| Length | | Sub-Sub-TLVs are included for each SID Type. |
| RESERVED | 1 | This field MUST be set to 0 by the sender and |
| 1 | octet | ignored by the receiver. |
| SRv6 SID | 16 | This field encodes an SRv6 SID |
| Value | Octets | |
| SRv6 | 1 | This field encodes SRv6 Service SID Flags -- |
| Service | Octet | none are currently defined. It MUST be set to |
| SID Flags | | 0 by the sender and any unknown flags |
| | | MUST be ignored by the receiver. |
| SRv6 | 2 | This field encodes the SRv6 Endpoint Behavior |
| Endpoint | Octets | codepoint value that is associated with the |
| Behavior | | SRv6 SID. The codepoints used are from IANA's |
| | | “SRv6 Endpoint Behaviors” sub registry |
| | | under the “Segment Routing” registry |
| | | that was introduced by [RFC8986]. The |
| | | opaque SRv6 Endpoint Behavior (i.e., value |
| | | 0xFFFF) MAY be used when the advertising |
| | | router wishes to abstract the actual behavior |
| | | of its locally instantiated SRv6 SID. |
| RESERVED | 1 | This field MUST be set to 0 by the sender and |
| 2 | Octet | ignored by the receiver. |
| SRv6 | Vari- | This field is used to advertise properties of the |
| Service Data | able | SRv6 SID. It is encoded as a set of SRv6 Service |
| Sub-Sub- | | Data Sub-Sub-TLVs |
| TLV Value | | |

### SRv6 SID Structure Sub-Sub-TLV

The structure of the SID Structure Sub-Sub-TLVs 14 is as described in RFC 9252, FIG. 5. Of note, the SRv6 SID Information Sub-TLV 12 with new Service SID TLV type denotes the fact there will be more than one SID Structure Sub-Sub-TLVs 14, thereby supporting multiple SID types.

| Field | Length | Description |
|---|---|---|
| SRv6 Service | 1 Octet | This field is set to 1 to represent the |
| Data Sub- | | SRv6 SID Structure Sub-Sub-TLV |
| Sub-TLV | | |
| Type | | |
| SRv6 Service | 2 Octets | This field contains a total length of 6 octets. |
| Data Sub- | | |
| Sub-TLV | | |
| Length | | |
| Locator Block | 1 Octet | This field contains the length of the SRv6 SID |
| Length | | Locator Block in bits. |
| Locator Node | 1 Octet | This field contains the length of the SRv6 SID |
| Length | | Locator Node in bits. |
| Function | 1 Octet | This field contains the length of the SRv6 SID |
| Length | | Function in bits. |
| Argument | 1 Octet | This field contains the length of the SRv6 SID |
| Length | | Argument in bits. |
| Transposition | 1 Octet | This field is the size in bits for the part of |
| Length | | the SID that has been transposed (or shifted) |
| | | into an MPLS Label field |
| Transposition | 1 Octet | This field is the offset position in bits for |
| Offset | | the part of the SID that has been transposed |
| | | (or shifted) into an MPLS Label field. |

Of note, the SRv6 SID Structure Sub-Sub-TLV 14 contains appropriate length fields when the SRv6 Service SID is signaled in split parts to enable the receiver to put together the SID accurately. Thus, having multiple SRv6 SID Structure Sub-Sub-TLVs 14 in the SRv6 SID Information Sub-TLV 12 allows multiple SID structures, i.e., SID types, to be associated with the same SRv6 Service SID. Again, an example of this can include an uncompressed SID and a uSID for the same SRv6 Service SID, allowing ingress PEs to reach the advertising PE with each the uncompressed SID or the uSID.

In addition to the uncompressed SID or the uSID, any other type of SID can be advertised in the SRv6 SID Structure Sub-Sub-TLV 14, e.g., a generalized SID.

### Operation

A BGP speaker receiving SRv6 Service SID TLV 12 with type=2, i.e., the new Service SID TLV type, needs to decode the advertised SID types available in the Sub-Sub-TLVs 14 and choose one of the SID types based on its capability or local policy. Here, capability means what the BGP speaker supports or is configured to support. For example, some PEs may only support uncompressed SIDs, while others may only support uSIDs, or further some PEs can be configured to support only one or the other. For local policy, this assumes the BGP speaker supports the multiple SID types, but prefers (policy) one over another. For example, for Service Function Chaining (SFC), use the uncompressed SID, and for Traffic Engineering (TE), use the uSID.

A BGP speaker will decide the advertising procedure to use based on:

(1) Option 1: Configuration, such as a Command Line Interface (CLI) knob to enable this solution, use of YANG, etc.

(2) Option 2: A new Capability can be introduced for this solution as per RFC 5492, Capabilities Advertisement with BGP-4, February 2009, the contents of which are incorporated by reference. When the peers exchange this new Capability, both the peers can negotiate and learn each other's support for this solution.

(3) Option 3: When there is no CLI knob or Capability available, then this solution can be in disabled state and the procedure will be simply as per RFC 9252, type=1.

### Error Handling

When the receiving PE does not support SRv6 Service SID TLV with type=2, i.e., the new Service SID TLV type, it should follow it should Update Message Error Handling procedure specified in RFC 4271, A Border Gateway Protocol 4 (BGP-4), January 2006, the contents of which are incorporated by reference. When the error is detected, it should be indicated by sending the NOTIFICATION message with Error Code UPDATE Message Error. The error subcode will elaborate on the specific nature of the error. Since it is an optional attribute, the attribute will be discarded, and the Error Subcode will be set to Optional Attribute Error. The data field will contain the attribute (type, length, and value).

### Process

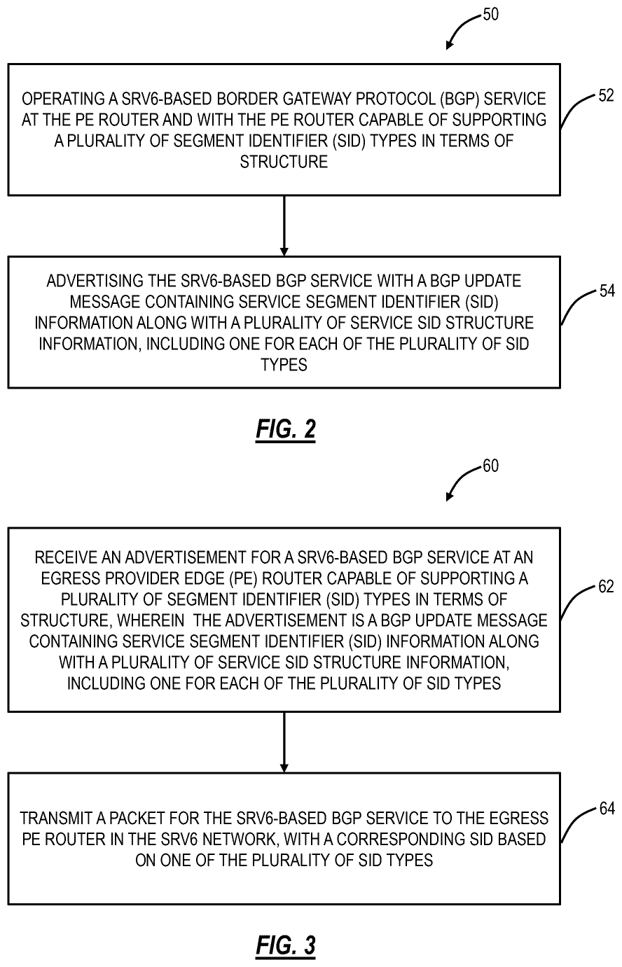

FIG. 2 is a flowchart of a process 50 for Border Gateway Protocol (BGP)-based service support over a Segment Routing over Internet Protocol version 6 (SRv6) network with different Segment Identifier (SID) types used therein. The process 50 contemplates operation as a method having steps, via a BGP speaker configured to implement the steps, via a PE router configured to implement the steps, via circuitry configured to implement the steps, and as a non-transitory computer-readable medium storing instructions that, when executed, cause circuitry to implement the steps. In particular, a PE router can use the process 100 to advertise multiple SID types with the same SRv6 Service SID, as well as receive similar advertisements and use these to reach an egress PE router with different SIDs, based on either capability or local policy.

The process 50 includes operating a SRv6-based Border Gateway Protocol (BGP) service at the PE router and with the PE router capable of supporting a plurality of Segment Identifier (SID) types in terms of structure (step 52); and advertising the SRv6-based BGP service with a BGP Update message containing Service Segment Identifier (SID) information along with a plurality of Service SID Structure information, including one for each of the plurality of SID types (step 54).

The process 50 can further include receiving a packet for the SRv6-based BGP service from another PE router in the SRv6 network, with a corresponding SID based on one of the plurality of SID types. The process 50 can further include receiving a packet for the SRv6-based BGP service from another PE router in the SRv6 network, with a corresponding SID based on one of the plurality of SID types, the corresponding SID selected based on one of capability of the another PE router and local policy.

The Service SID information can be a Service SID Type-Length-Value (TLV) having a new Service SID TLV type that designates there are the plurality of Service SID Structure information. The Service SID information can be a Service SID Type-Length-Value (TLV) having a new Service SID TLV type that designates there are the plurality of Service SID Structure information, and the plurality of Service SID Structure information each include a SID Structure Sub-Sub-TLV. The plurality of SID types can include an uncompressed SID and a micro SID (uSID).

The process 50 can further include receiving a configuration for the plurality of SID types for the SRv6-based BGP service. The process 50 can further include exchanging a capability with one or more other PE routers in the SRv6 network; for any of the one or more other PE routers supporting the BGP Update message containing Service SID information along with the plurality of Service SID Structure information, performing the advertising; and, for any of the one or more other PE routers not supporting the BGP Update message containing Service SID information along with the plurality of Service SID Structure information, advertising the SRv6-based BGP service with a BGP Update message containing Service SID information along with a single Service SID Structure information.

FIG. 3 is a flowchart of a process 60 for a BGP speaker and BGP-based service support over a SRv6 network with different SID types used therein. The process 60 contemplates operation as a method having steps, via a BGP speaker configured to implement the steps, via a PE router configured to implement the steps, via circuitry configured to implement the steps, and as a non-transitory computer-readable medium storing instructions that, when executed, cause circuitry to implement the steps.

The process 60 includes receiving an advertisement for a SRv6-based BGP service at an egress Provider Edge (PE) router capable of supporting a plurality of Segment Identifier (SID) types in terms of structure, wherein the advertisement is a BGP Update message containing Service Segment Identifier (SID) information along with a plurality of Service SID Structure information, including one for each of the plurality of SID types (step 62); and transmitting a packet for the SRv6-based BGP service to the egress PE router in the SRv6 network, with a corresponding SID based on one of the plurality of SID types (step 64).

The corresponding SID can be selected based on one of capability of the another PE router and local policy. The Service SID information can be a Service SID Type-Length-Value (TLV) having a new Service SID TLV type that designates there are the plurality of Service SID Structure information, and the plurality of Service SID Structure information each include a SID Structure Sub-Sub-TLV. The plurality of SID types can include an uncompressed SID and a micro SID (uSID).

### Example Node

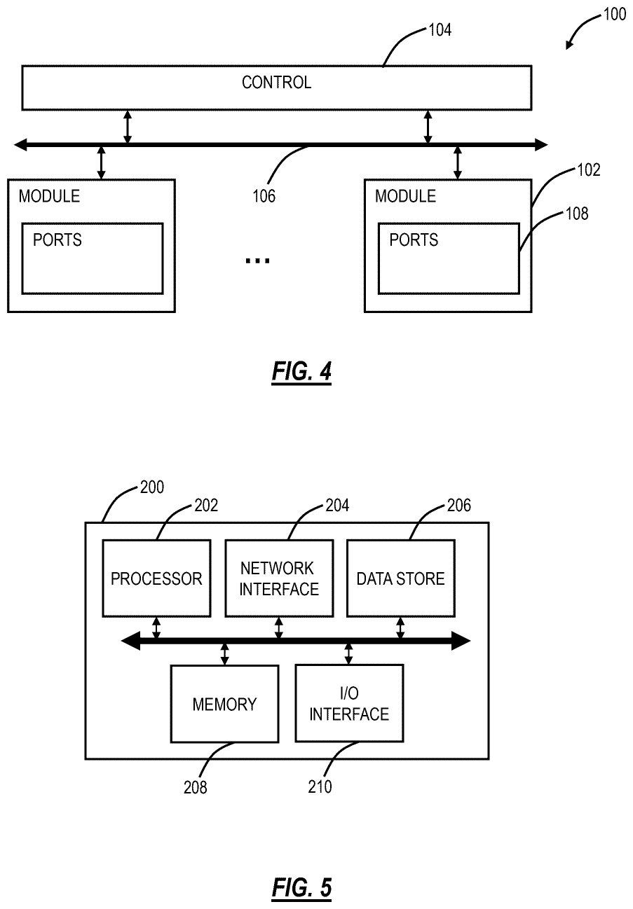

FIG. 4 is a block diagram of an example implementation of a router 100, such as a PE router, BGP speaker, etc. Those of ordinary skill in the art will recognize FIG. 4 is a functional diagram in an oversimplified manner, and a practical embodiment may include additional components and suitably configured processing logic to support known or conventional operating features that are not described in detail herein.

In this embodiment, the router 100 includes a plurality of modules 102, 104 interconnected via an interface 106. The modules 102, 104 are also known as blades, line cards, line modules, circuit packs, pluggable modules, etc. and generally refer to components mounted on a chassis, shelf, etc. of a data switching device, i.e., the router 100. Each of the modules 102, 104 can include numerous electronic devices and/or optical devices mounted on a circuit board along with various interconnects, including interfaces to the chassis, shelf, etc.

Two example modules are illustrated with line modules 102 and a control module 104. The line modules 102 include ports 108, such as a plurality of Ethernet ports. For example, the line module 102 can include a plurality of physical ports disposed on an exterior of the module 102 for receiving ingress/egress connections. Additionally, the line modules 102 can include switching components to form a switching fabric via the interface 106 between all of the ports 108, allowing data traffic to be switched/forwarded between the ports 108 on the various line modules 102. The switching fabric is a combination of hardware, software, firmware, etc. that moves data coming into the router 100 out by the correct port 108 to the next router 100. “Switching fabric” includes switching/routing units in a node; integrated circuits contained in the switching units; and programming that allows switching paths to be controlled. Note, the switching fabric can be distributed on the modules 102, 104, in a separate module (not shown), integrated on the line module 102, or a combination thereof.

The control module 104 can include a microprocessor, memory, software, and a network interface. Specifically, the microprocessor, the memory, and the software can collectively control, configure, provision, monitor, etc. the router 100. The network interface may be utilized to communicate with an element manager, a network management system, the controller 12, etc. Additionally, the control module 104 can include a database that tracks and maintains provisioning, configuration, operational data, and the like.

Again, those of ordinary skill in the art will recognize the router 100 can include other components which are omitted for illustration purposes, and that the systems and methods described herein are contemplated for use with a plurality of different network elements with the router 100 presented as an example type of network element. For example, in another embodiment, the router 100 may include corresponding functionality in a distributed fashion. In a further embodiment, the chassis and modules may be a single integrated unit, namely a rack-mounted shelf where the functionality of the modules 102, 104 is built-in, i.e., a “pizza-box” configuration. That is, FIG. 4 is meant to provide a functional view, and those of ordinary skill in the art will recognize actual hardware implementations may vary.

### Example Processing Device

FIG. 5 is a block diagram of an example processing device 200. Also, the processing device 200 can be referred to in implementations as a control module, a shelf controller, a shelf processor, a system controller, etc. The processing device 200 can include a processor 202 which is a hardware device for executing software instructions. The processor 202 can be any custom made or commercially available processor, a Central Processing Unit (CPU), an auxiliary processor among several processors associated with the processing device 200, a semiconductor-based microprocessor (in the form of a microchip or chipset), or generally any device for executing software instructions. When the processing device 200 is in operation, the processor 202 is configured to execute software stored within the memory, to communicate data to and from the memory, and to generally control operations of the processing device 200 pursuant to the software instructions. The processing device 200 can also include a network interface 204, a data store 206, memory 208, an I/O interface 210, and the like, all of which are communicatively coupled to one another and to the processor 202.

The network interface 204 can be used to enable the processing device 200 to communicate on a data communication network, such as to communicate to a management system, or the like. The network interface 204 can include, for example, an Ethernet module. The network interface 204 can include address, control, and/or data connections to enable appropriate communications on the network. The data store 206 can be used to store data, such as control plane information, provisioning data, Operations, Administration, Maintenance, and Provisioning (OAM&P) data, etc. The data store 206 can include any volatile memory elements, e.g., random access memory (RAM, such as DRAM, SRAM, SDRAM, and the like), nonvolatile memory elements (e.g., ROM, hard drive, flash drive, CDROM, and the like), and combinations thereof.

Moreover, the data store 206 can incorporate electronic, magnetic, optical, and/or other types of storage media. The memory 208 can include any volatile memory elements, e.g., random access memory (RAM, such as DRAM, SRAM, SDRAM, etc.), nonvolatile memory elements (e.g., ROM, hard drive, flash drive, CDROM, etc.), and combinations thereof. Moreover, the memory 208 may incorporate electronic, magnetic, optical, and/or other types of storage media. Note that the memory 208 can have a distributed architecture, where various components are situated remotely from one another, but may be accessed by the processor 202. The I/O interface 210 includes components for the processing device 200 to communicate with other devices.

### CONCLUSION

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including software and/or firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” “a circuit configured to,” “one or more circuits configured to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. Further, the various elements, operations, steps, methods, processes, algorithms, functions, techniques, modules, circuits, etc. described herein contemplate use in any and all combinations with one another, including individually as well as combinations of less than all of the various elements, operations, steps, methods, processes, algorithms, functions, techniques, modules, circuits, etc.

What is claimed is:

1. A non-transitory computer-readable medium comprising instructions that, when executed, cause a Provider Edge (PE) router, in a Segment Routing over Internet Protocol version 6 (SRv6) network, to perform steps of:
operating a SRv6-based Border Gateway Protocol (BGP) service at the PE router and with the PE router capable of supporting a plurality of Segment Identifier (SID) types in terms of structure; and
advertising the SRv6-based BGP service with a BGP Update message containing Service Segment Identifier (SID) information along with a plurality of Service SID Structure information, including one for each of the plurality of SID types.

2. The non-transitory computer-readable medium of claim 1, wherein the instructions that, when executed, cause the PE router, to further perform steps of
receiving a packet for the SRv6-based BGP service from another PE router in the SRv6 network, with a corresponding SID based on one of the plurality of SID types.

3. The non-transitory computer-readable medium of claim 1, wherein the instructions that, when executed, cause the PE router, to further perform steps of
receiving a packet for the SRv6-based BGP service from another PE router in the SRv6 network, with a corresponding SID based on one of the plurality of SID types, the corresponding SID selected based on one of capability of the another PE router and local policy.

4. The non-transitory computer-readable medium of claim 1, wherein the Service SID information is a Service SID Type-Length-Value (TLV) having a Service SID TLV type that designates there are the plurality of Service SID Structure information.

5. The non-transitory computer-readable medium of claim 1, wherein the Service SID information is a Service SID Type-Length-Value (TLV) having a Service SID TLV type that designates there are the plurality of Service SID Structure information, and the plurality of Service SID Structure information each include a SID Structure Sub-Sub-TLV.

6. The non-transitory computer-readable medium of claim 1, wherein the plurality of SID types include an uncompressed SID and a micro SID (uSID).

7. The non-transitory computer-readable medium of claim 1, wherein the instructions that, when executed, cause the PE router, to further perform steps of receiving a configuration for the plurality of SID types for the SRv6-based BGP service.

8. The non-transitory computer-readable medium of claim 1, wherein the instructions that, when executed, cause the PE router, to further perform steps of
exchanging a capability with one or more other PE routers in the SRv6 network; and
for any of the one or more other PE routers supporting the BGP Update message containing Service SID information along with the plurality of Service SID Structure information, performing the advertising.

9. The non-transitory computer-readable medium of claim 8, wherein the instructions that, when executed, cause the PE router, to further perform steps of
for any of the one or more other PE routers not supporting the BGP Update message containing Service SID information along with the plurality of Service SID Structure information, advertising the SRv6-based BGP service with a BGP Update message containing Service SID information along with a single Service SID Structure information.

10. A method implemented by a Provider Edge (PE) router, in a Segment Routing over Internet Protocol version 6 (SRv6) network, the method comprising steps of:
operating a SRv6-based Border Gateway Protocol (BGP) service at the PE router and with the PE router capable of supporting a plurality of Segment Identifier (SID) types in terms of structure; and
advertising the SRv6-based BGP service with a BGP Update message containing Service Segment Identifier (SID) information along with a plurality of Service SID Structure information, including one for each of the plurality of SID types.

11. The method of claim 10, wherein the steps further include
receiving a packet for the SRv6-based BGP service from another PE router in the SRv6 network, with a corresponding SID based on one of the plurality of SID types.

12. The method of claim 10, wherein the steps further include
receiving a packet for the SRv6-based BGP service from another PE router in the SRv6 network, with a corresponding SID based on one of the plurality of SID types, the corresponding SID selected based on one of capability of the another PE router and local policy.

13. The method of claim 10, wherein the Service SID information is a Service SID Type-Length-Value (TLV) having a Service SID TLV type that designates there are the plurality of Service SID Structure information.

14. The method of claim 10, wherein the Service SID information is a Service SID Type-Length-Value (TLV) having a Service SID TLV type that designates there are the plurality of Service SID Structure information, and the plurality of Service SID Structure information each include a SID Structure Sub-Sub-TLV.

15. The method of claim 10, wherein the plurality of SID types includes an uncompressed SID and a micro SID (uSID).

16. The method of claim 10, wherein the steps further include receiving a configuration for the plurality of SID types for the SRv6-based BGP service.

17. The method of claim 10, wherein the steps further include
exchanging a capability with one or more other PE routers in the SRv6 network;
for any of the one or more other PE routers supporting the BGP Update message containing Service SID information along with the plurality of Service SID Structure information, performing the advertising.

18. The method of claim 17, wherein the steps further include
for any of the one or more other PE routers not supporting the BGP Update message containing Service SID information along with the plurality of Service SID Structure information, advertising the SRv6-based BGP service with a BGP Update message containing Service SID information along with a single Service SID Structure information.

19. A Border Gateway Protocol (BGP) speaker in a Segment Routing over Internet Protocol version 6 (SRv6) network, the BGP speaker comprising circuitry configured to:
receive an advertisement for a SRv6-based BGP service at an egress Provider Edge (PE) router capable of supporting a plurality of Segment Identifier (SID) types in terms of structure, wherein the advertisement is a BGP Update message containing Service Segment Identifier (SID) information along with a plurality of Service SID Structure information, including one for each of the plurality of SID types; and
transmit a packet for the SRv6-based BGP service to the egress PE router in the SRv6 network, with a corresponding SID based on one of the plurality of SID types.

20. The BGP speaker of claim 17, wherein the corresponding SID is selected based on one of capability of another PE router and local policy.
